(19) United States
(12) Patent Application Publication
(10) Pub. No.: US 2009/0184811 A1
(43) Pub. Date: Jul. 23, 2009

(54) METHODS AND SYSTEM FOR AN IMPACT AVOIDANCE SYSTEM

(76) Inventor: Nicholas K. Althoff, Ware Shoals, SC (US)

Correspondence Address: JOHN S. BEULICK (17851);ARMSTRONG TEASDALE LLP, ONE METROPOLITAN SQUARE, SUITE 2600, ST. LOUIS, MO, 63102-2740, US

(21) Appl. No.: 12/018,307

(22) Filed: Jan. 23, 2008

(51) Int. Cl. B60Q 1/00

(52) U.S. Cl. 340/435; 340/686.6

(57) ABSTRACT

A system and methods of impact avoidance for a load transport system are provided. The method includes coupling an elongated load to a transport vehicle, wherein the load includes a supported portion and a cantilevered portion such that the cantilevered portion exceeds a support dimension of the transport vehicle. The method further includes coupling at least one proximity sensor to the load, determining a distance from either the proximity sensor or the load to an object in the field of view of the sensor, transmitting the signal corresponding to the determined distance to a control unit, comparing the determined distance to a predetermined allowable clearance distance and generating a signal based on the comparison.

### BACKGROUND OF THE INVENTION

The field of the invention relates generally to impact avoidance systems, and more particularly to methods and a system for use in an impact avoidance system.

During use known impact avoidance systems are used to prevent collisions between a vehicle and stationary or moving objects. For example, at least some known impact avoidance systems are used on automobiles, trucks, vehicles with trailers, planes (when taxiing on the ground), and heavy equipment such as fork lifts, bulldozers, scrapers, boats, ships, and/or tractor trailers. Such systems may use one or more proximity sensors that are positioned at various locations on the vehicle, a controller that communicates with the sensors, and a warning device such as an audio, visual, and/or haptic device that communicates with the controller.

At least some known impact avoidance systems position at least one sensor on a rear portion of the vehicle as well as at least one sensor positioned along the sides and/or front of the vehicle. Known sensors include optical sensors such as lasers, ultrasonic sensors, infrared sensors, and/or radio frequency (RF) sensors. During use, at least some known sensors periodically transmit sensing signals into a sensing zone where objects located in the sensing zone reflect the sensing signals. The timing and amplitude of the reflected signals are used to estimate a distance between the object and that sensor and are used to warn a driver of the vehicle, if necessary. For example, if a sensor output indicates that an object is less than a preset distance, the collision avoidance system generates a warning signal. However, problems may arise when transporting elongated loads which include a portion, such as a distal end, that extends beyond the longitudinal length of the transport trailer. For example, because of the orientation of the distal end of the load, it may be difficult for a driver of the transportation vehicle to judge a distance between the distal end of the load and objects that may approach the load as the vehicle is maneuvering during transit.

### BRIEF DESCRIPTION OF THE INVENTION

In one embodiment, an impact avoidance system is provided. The system includes at least one proximity sensor coupled to a load, said sensor comprising a field of view, at least one control unit configured to receive a signal from said at least one proximity sensor, and a load adjuster configured to maneuver the load in response to the signal received from said at least one control unit.

In another embodiment, a method for impact avoidance in a load transport system is provided. The method includes coupling a load to a transport vehicle, wherein the load comprises a supported portion and a cantilevered portion such that the cantilevered portion exceeds a support dimension of the transport vehicle. The method also includes coupling at least one proximity sensor to the load, said sensor comprising a field of view. Furthermore, the method includes determining a distance from at least one of the proximity sensor and the load to an object in the field of view of the sensor, comparing the determined distance to a predetermined allowable clearance distance, generating a signal based on the comparison and transmitting a signal corresponding to the determined distance to a control unit.

In yet another embodiment, a method for impact avoidance in a load transport system is provided. The method includes coupling a load to a transport vehicle, wherein the load comprises a supported portion and a cantilevered portion such that the cantilevered portion exceeds a support dimension of the transport vehicle. The method also includes positioning at least one proximity sensor such that the load is within a field of view of the sensor. Furthermore, the method includes determining a relative velocity vector of an object in the field of view of the sensor with respect to at least one of the proximity sensor and the load, determining whether the object will impact the at least one of the proximity sensor and the load based on the determined relative velocity, and generating a signal based on the determination.

### BRIEF DESCRIPTION OF THE DRAWINGS

FIG. 1 is a schematic view of an exemplary embodiment of a load transport proximity sensor system.

FIG. 2 is a flow chart of an exemplary method that may be used with the system shown in FIG. 1 to sense the proximity of objects in relation to a transported load based on a determination of positioning.

FIG. 3 is a flow chart of an exemplary method that may be used with the system shown in FIG. 1 to sense the proximity of objects in relation to a transported load based on a determination of velocities.

### DETAILED DESCRIPTION OF THE INVENTION

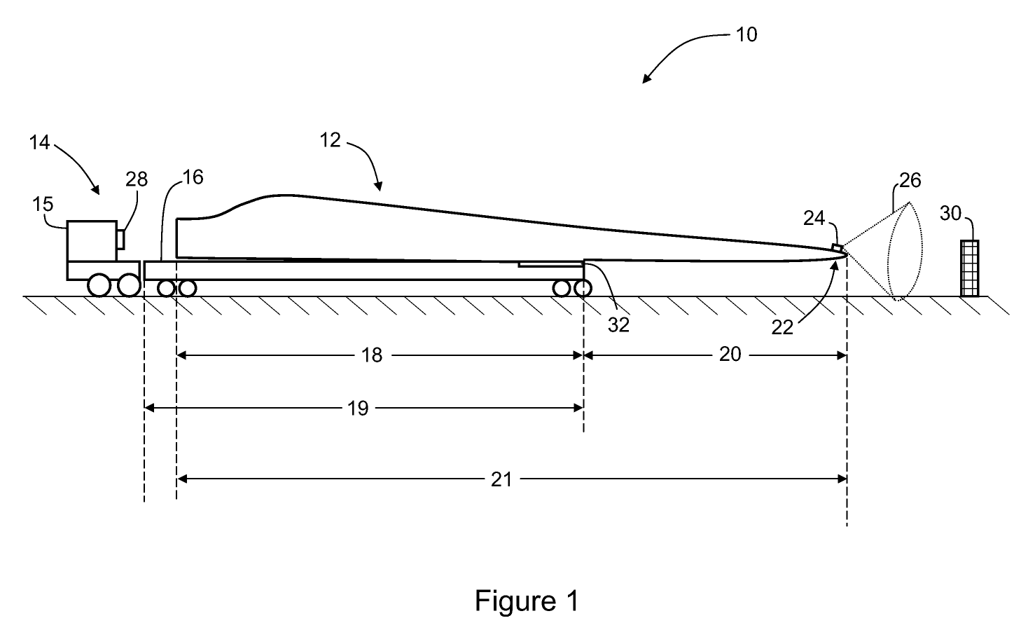

FIG. 1 is a schematic view of an exemplary load transport proximity sensor system 10. In the exemplary embodiment, system 10 includes a load 12 being transported by a transport vehicle 14 that includes a passenger compartment 15. A semi-trailer 16 including a load floor 19 is coupled to the transport vehicle 14. In the exemplary embodiment, load 12 is at least one wind turbine blade that is coupled to load floor 19. Alternatively, load 12 may be any elongated structure that includes a portion that extends passed load floor 19. In the exemplary embodiment, semi-trailer 16 is a flat-bed semi-trailer that includes load floor 19, removable side rails (not shown), and a bulkhead (not shown) that facilitates protecting transport vehicle 14 in the event of a load shift. Alternatively, semi-trailer 16 may be any trailer suitable for towing an elongated load.

Load 12 is removably coupled to semi-trailer 16 such that a supported portion 18 is supported against load floor 19 and a cantilevered portion 20 extends a distance outward from load floor 19 and is suspended in the air above the ground. More specifically, in the exemplary embodiment, load 12 has a length 21 that is longer than a length 19 of trailer 16 such that cantilevered portion 20 extends outward from load floor 19 to a distal end 22.

A sensor 24 coupled to cantilevered portion 20 includes a field of view 26, defined by sensor specifications, that enables sensor 24 to measure a physical property of an object 30 within field of view 26. More specifically, in the exemplary embodiment, sensor 24 is positioned at distal end 22 such that an object that threatens to imminently impact load 12 may be detected. Furthermore, in the exemplary embodiment, field of view 26 extends generally circumferentially about distal end 22. Alternatively, field of view 26 may extend spherically or partially spherically about distal end 22. In an alternative embodiment, a sensor array (not shown) including a plurality of sensors may be positioned at any location on load 12 to detect any object that threatens to impact load 12. In the exemplary embodiment, sensor 24 is an infrared-proximity sensor that uses triangulation to sense the desired physical property of object 30. Alternatively, an infrared sensor may use a reflection or modulation process to function as described herein. Furthermore, sensor 24 may be a sonic sensor, an optical sensor, and/or a laser sensor that uses any applicable method to function as described herein.

In the exemplary embodiment, system 10 includes a control unit 28 that generates feedback to a user (not shown) monitoring load 12 based on data received from sensor 24. More specifically, control unit 28 is positioned in passenger compartment 15. Alternatively, the control unit may be positioned in a trailing support safety car (not shown) or in any other location that enables system 10 to function as described herein. In operation, control unit 28 receives a signal from a sensor 24 that contains information regarding the property being measured. Control unit 28 then determines, as described herein, whether an impact is imminent.

A load adjuster 32 is coupled to semi-trailer 16. Load adjuster 32 enables load 12 to be maneuvered on semi-trailer 16, i.e., raised and/or lowered, in response to data received from the sensor. In the exemplary embodiment, load adjuster 32 is configured such that upon receipt of a signal from control unit 28 indicative of an imminent impact, load 12 may be maneuvered by an external controller (not shown) to facilitate avoiding the impact. Alternatively, load adjuster 32 may be automatically maneuvered by control unit 28 upon the determination that an impact is imminent. In the exemplary embodiment, load adjuster 32 is a hydraulic lift platform that is positioned within load floor 19. Alternatively, load adjuster 32 may be pneumatic, mechanical, electrical and/or any suitable combination so that the system may function as described herein.

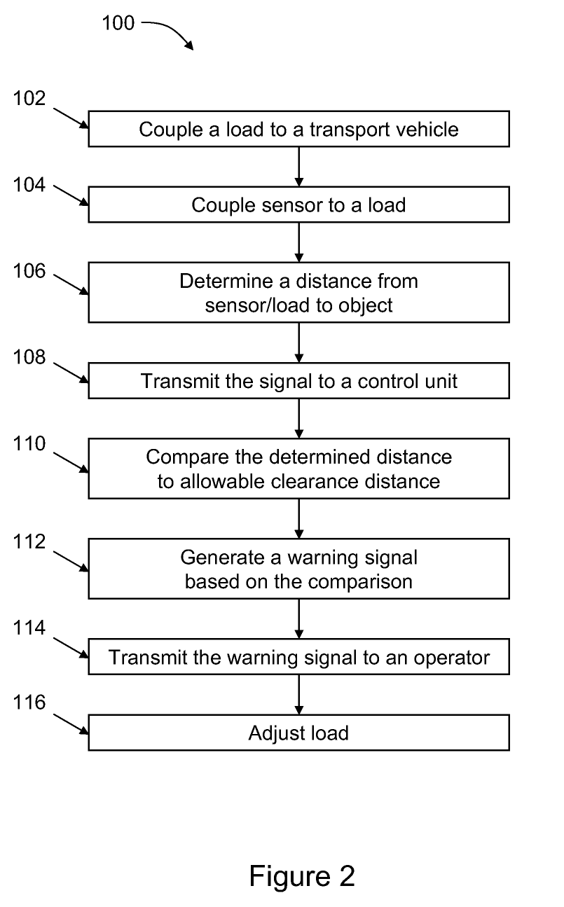

FIG. 2 is a flow chart of an exemplary method 100 that may be used to sense the proximity of objects in relation to a transported load, such as load 12 (shown in FIG. 1). In the exemplary embodiment, method 100 includes coupling a load 102 to a transport vehicle wherein the load is an elongated load that extends outward a distance from the transport vehicle, such that a supported portion of the load and a cantilevered or unsupported portion of the load are created. Moreover, a distal end of the load is located at a point on the load that is farthest from the transport vehicle.

A sensor is then coupled to the load 104 such that the sensor has a field of view that extends outward from the load. In the exemplary embodiment, the sensor is an infrared sensor. However, the sensor may be any type of sensor for use as a proximity sensor, such a sonic sensor, a laser sensor, or an optical sensor. Additionally, in the exemplary method, the sensor is coupled to the distal end of the load. Alternatively, the sensor may be coupled to any portion of the cantilevered portion of the load that may by susceptible of impact with an object. Moreover, a sensor array including a plurality of sensors may be coupled to a plurality of locations on the load that enables the invention to function as described herein.

The sensor then determines a distance 106 to an object within the sensor's field of view. In the exemplary embodiment, the sensor determines the distance 106 to the object within the field of view, relative to the sensor. Alternatively, the sensor determines the distance 106 to the object relative to any point on the load that is susceptible of impact with an approaching object. In the exemplary embodiment, in determining the distance 106, the sensor uses triangulation to determine a position at any point on the load, determine the distance of the approaching object relative to the point on the load and then determine the distance therebetween. Alternatively, the distance determination 106 may be via simple reflection (i.e. an LED and photodiode) and/or via modulation. In the exemplary embodiment, the object is a stationary object, such as a building, wall, fence, or the road. Alternatively, the object is a moving object, such as another vehicle.

A signal representative of the determined distance is then transmitted from the sensor 108 to a control unit with the distance information embedded therein. In the exemplary embodiment, the sensor is directly connected to the control unit via an electrical cable system. Alternatively, the sensor may transmit a signal from the sensor 108 wirelessly to the control unit. Alternatively, the signal may be sent to the control unit via any means that enables the system to function as described herein.

In the exemplary embodiment, the control unit is pre-programmed with a clearance distance range. The clearance distance range is a measure of a pre-determined distance that triggers an imminent threat of impact alarm described in more detail below, within which an object poses a threat of imminent impact with the load. Following receipt of the distance signal from the sensor, the control unit compares 110 the determined distance 106 to the pre-determined clearance distance range value.

If the control unit determines that the object is within the pre-determined clearance distance range, and as such poses an imminent threat of impact, the control unit generates an imminent impact signal 112 based upon the comparison 110. In the exemplary embodiment, the imminent impact signal is transmitted to an operator 114 monitoring the load inside the transport vehicle. Alternatively the operator may be located in any suitable location for monitoring the load, such as but not limited to the transport vehicle or a trailing support safety car. The operator will then adjust the load accordingly 116. In the exemplary embodiment, the operator engages a load adjuster to maneuver the load 116 to avoid the potential impact. Alternatively, the load adjuster may be configured to automatically maneuver the load from the approaching object upon receipt of the imminent impact signal from the control unit.

Further, although the present invention is described with respect to processors and computer programs, as will be appreciated by one of ordinary skill in the art, the present invention may also apply to any system and/or program that is configured to prevent collisions between a vehicle/load and stationary or moving objects. For example, as used herein, the term processor is not limited to just those integrated circuits referred to in the art as processors, but broadly refers to computers, processors, microcontrollers, microcomputers, programmable logic controllers, application specific integrated circuits, and other programmable circuits. The processor may be part of a computer that may include a device, such as; a floppy disk drive or compact disc-read-only memory (CD-ROM) drive, for reading data from a computer-readable medium, such as a floppy disk, a CD-ROM, a magneto-optical disk (MOD), or a digital versatile disc (DVD).

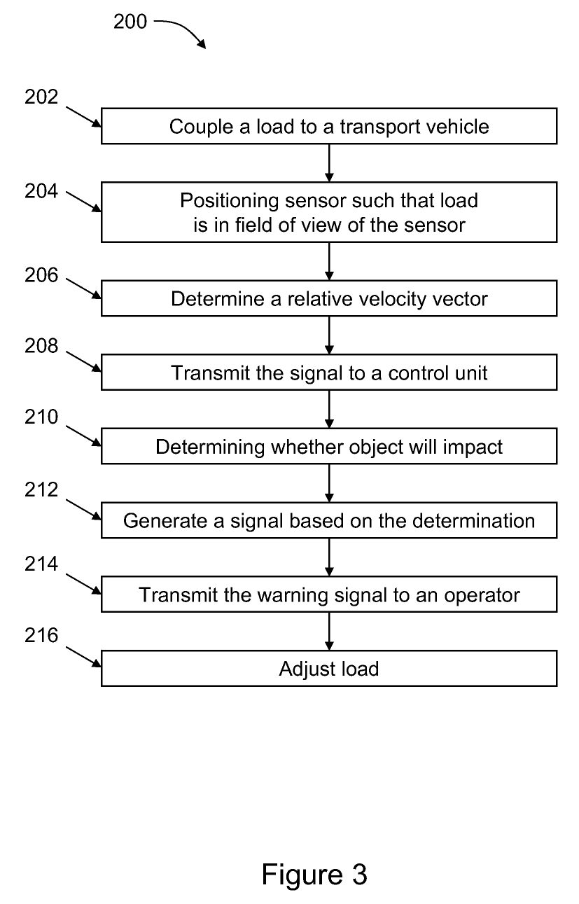

FIG. 3 is a flow chart of an exemplary method 200 that may be used to sense the velocities of objects in relation to a transported load, such as load 12 (shown in FIG. 1). Method 200 includes coupling a load 202 to a transport vehicle such that the load is an elongated load that extends outward a distance from the transport vehicle, such that a supported portion of the load and a cantilevered or unsupported portion of the load are created. Moreover, a distal end of the load is located at a point on the load that is farthest from the transport vehicle.

A sensor is then coupled to the load 204 such that the sensor has a field of view that extends outward from the load. In the exemplary embodiment, the sensor is an infrared sensor. However, the sensor may be any type of sensor for use as a proximity sensor, such a sonic sensor, a laser sensor, or an optical sensor. Additionally, in the exemplary method, the sensor is coupled to the distal end of the load. Alternatively, the sensor may be coupled to any portion of the cantilevered portion of the load that may be susceptible to impact with an object. Moreover, a sensor array including a plurality of sensors may be coupled to a plurality of locations on the load that enables the invention to function as described herein.

In the exemplary embodiment, the sensor will determine the relative velocity vector 206 of an object in passing through the field of view of the sensor relative to either the sensor or a point on the load. The sensor transmits 208 the relative velocity vector signal to a control unit with the distance information embedded therein. In the exemplary embodiment, the sensor is directly connected to the control unit via an electrical cable system. Alternatively, the sensor may transmit a signal over from the sensor wirelessly to the control unit. Alternatively, the relative velocity vector signal may be sent to the control unit via any method that allows the system to function as described herein.

In the exemplary embodiment, the control unit is pre-programmed to facilitate determining the relative velocity vector of the load and/or transport vehicle. Following receipt of the relative velocity signal from the sensor 208, the control unit compares the relative velocity vector of the object with the relative velocity vector of the load and/or transport vehicle to facilitate determining 210 whether an imminent impact is likely to occur 210.

In the exemplary embodiment, upon determination 210 by the control unit that the object poses an imminent threat of impact with the object from the velocity vector determination, the control unit generates an imminent impact signal 212 based upon the determination 210. In the exemplary embodiment, the imminent impact signal is transmitted to an operator 214 monitoring the load inside the transport vehicle. Alternatively the operator may be located in any suitable location for monitoring the load, such as but not limited to the transport vehicle or a trailing support safety car. The operator will then adjust the load accordingly 216.

Exemplary embodiments of impact avoidance systems are described in detail above. The above-described impact avoidance systems and methods of detecting and avoiding potential impacts upon wind turbine blades, or any elongated load, may be implemented to facilitate safely transporting such loads, as well as to facilitate avoiding controller error. Additionally, the systems and methods described herein facilitate adjusting the position of the load relative to a potentially hazardous object to avoid an imminent impact.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Although the apparatus and methods described herein are described in the context of using a proximity sensor within an impact avoidance system for use in hauling wind turbine blades, it is understood that the apparatus and methods are not limited to the transport of turbine blades. Likewise, the system components illustrated are not limited to the specific embodiments described herein, but rather, system components can be utilized independently and separately from other components described herein.

While the invention has been described in terms of various specific embodiments, those skilled in the art will recognize that the invention can be practiced with modification within the spirit and scope of the claims.

What is claimed is:

1. An impact avoidance system comprising:
at least one proximity sensor coupled to a load, said at least one sensor comprising a field of view;
at least one control unit configured to receive a signal from said at least one proximity sensor; and
a load adjuster configured to maneuver the load in response to the signal received from said at least one control unit.

2. A system in accordance with claim 1, wherein the at least one proximity sensor further comprises at least one of a sonic sensor, a laser sensor, an optical sensor and an infrared sensor.

3. A system in accordance with claim 1, wherein the load adjuster comprises at least one of a hydraulic load adjuster, a pneumatic load adjuster, a mechanical load adjuster and an electrical load adjuster.

4. A system in accordance with claim 1, wherein the at least one control unit is further configured to determine whether an impact is imminent in response to the received signal.

5. A system in accordance with claim 1, wherein the field of view of the sensor comprises at least one of an approximately spherical, partially spherical and approximately circumferential field of view.

6. A method for impact avoidance in a load transport system, said method comprising:
coupling a load to a transport vehicle, wherein the load comprises a supported portion and a cantilevered portion such that the cantilevered portion exceeds a support dimension of the transport vehicle;
coupling at least one proximity sensor to the load, said sensor comprising a field of view;
determining a distance from at least one of the proximity sensor and the load to an object in the field of view of the sensor;
transmitting the signal corresponding to the determined distance to a control unit;
comparing the determined distance to a predetermined allowable clearance distance; and
generating a signal based on the comparison.

7. A method in accordance with claim 6, wherein transmitting a signal further comprises transmitting the determined signal to at least one of the control unit over a wireless network, the control unit over hard-wire, a cell phone and an email account.

8. A method in accordance with claim 6, wherein determining a distance to the object further comprises:
determining a position of at least one point on the load using the at least one proximity sensor;
determining a position of an approaching object relative to the determined point on the load; and
determining a distance therebetween.

9. A method in accordance with claim 6, wherein the load comprises a supported end and an opposing distal end and wherein coupling the at least one proximity sensor to a load further comprises coupling the at least one proximity sensor to the distal end of the load.

10. A method in accordance with claim 9, further comprising determining the location in space of the distal end of the load.

11. A method in accordance with claim 10, further comprising determining a position of an approaching object relative to the distal end of the load and calculating a distance therebetween.

12. A method in accordance with claim 6, further comprising positioning the control unit in at least one of an interior of a tracking vehicle and an interior of the transport vehicle.

13. A method in accordance with claim 6, wherein coupling at least one load further comprises coupling at least one wind turbine blade.

14. A method in accordance with claim 6, further comprising adjusting the position of the load to avoid an impact with the approaching object.

15. A method in accordance with claim 8, wherein determining a position of at least one point on the load using the at least one proximity sensor further comprises determining the position of at least one point on the load by triangulation.

16. A method in accordance with claim 6, further comprising determining a distance when the object is stationary.

17. A method in accordance with claim 6, further comprising determining a distance when the object is moving.

18. A method for impact avoidance in a load transport system, said method comprising:
coupling a load to a transport vehicle, wherein the load comprises a supported portion and a cantilevered portion such that the cantilevered portion exceeds a support dimension of the transport vehicle;
positioning at least one proximity sensor such that the load is within a field of view of the sensor;
determining a relative velocity vector of an object in the field of view of the sensor with respect to at least one of the proximity sensor and the load;
determining whether the object will impact the at least one of the proximity sensor and the load based on the determined relative velocity; and
generating a signal based on the determination.

19. A method in accordance with claim 18, wherein determining a relative velocity further comprises:
determining a velocity vector of the at least one proximity sensor;
determining a velocity vector the object; and
comparing the velocity vectors.

20. A method in accordance with claim 18, wherein determining whether the object will impact the at least one of the proximity sensor and the load further comprises determining a future position of the load and determining a future position of the object.
